(19) United States
(12) Patent Application Publication
(10) Pub. No.: US 2020/0409882 A1
(43) Pub. Date: Dec. 31, 2020

(54) FIBER CHANNEL STORAGE ZONING IN A CLOUD ENVIRONMENT

(71) Applicant: International Business Machines Corporation, Armonk, NY (US)

(72) Inventor: Gerald Francis McBrearty, Austin, TX (US)

(21) Appl. No.: 16/454,189

(22) Filed: Jun. 27, 2019

(51) Int. Cl. G06F 13/36

(52) U.S. Cl. CPC G06F 13/36; G06F 2213/38

(57) ABSTRACT

Machine logic implemented policies are created. These policies guide the automated creation of zoning between multiple VMs (virtual machines) and storage on SANs (storage area networks). This zoning controls hardware (such as communication ports) of various host physical machines, where the VMs and SANs are hosted and connected in mutual data communication. Some embodiments pick the ports (based on policy) to be used by the VM by pruning the list of ports from the VM and likewise the pruning the storage ports (by policy) to create the zone. In some embodiments, machine logic rule based policy(ies) determines which fabrics will be used between the VM and a storage array.

### BACKGROUND

It is known to deploy a VM (virtual machine) “by hand,” by picking he HBAs (host bus adapter ports) on the host and storage. This picking of HBAs is performed by the person, or persons, who deploy the VM and cause the VM to interact with its environment through the HBAs chosen by the human workers performing the deployment. The person(s) deploying the VM often proceed to perform the following operations: (i) the zoning; and (ii) creation of a LUN (“Logical Unit Number,” which is used in addressing a storage device). Zoning is a method of arranging SAN (storage area network) devices into logical groups over a physical fabric, or fabrics, to allow to allow entities such as VMs and Arrays to communicate data with each other. Typically, zoning is used to separate traffic so that only endpoints that are authorized to communicate data with each other will be able to communicate data with each other.

For example, consider a zoned computer system including: (i) a first set of endpoint devices designated as being in a first zone and assigned a first set of workloads, (ii) a second set of endpoint devices (mutually exclusive with respect to the first set of endpoint devices) designated as being in a second zone and assigned a second set of workloads. This will prevent data communications related to performing the first set of workloads from interfering, or taking bandwidth from, communications related to performing the second set of workloads. In other words, workloads in the first set of workloads are prevented from seeing workloads in the second set of workloads and vice versa, effectively isolating the traffic. Then zones can be: (i) “hard” zones where ports from the switch are connected to gather to make zone; or (ii) “soft,” which is also sometimes referred to as WWPN (worldwide port name) zoning.

Physical fabric (also sometimes herein more simply referred to as “fabric”) type includes the following: Fiber Channel, NVMe (non-volatile memory express), ib (infiniband), non-volatile memory express over fiber channel, ESCON (Enterprise Systems Connection) protocol fabric and/or FICON (Fibre Connection) protocol fabric.

“Plain disk,” or plain old storage, is sometimes herein referred to as JBOD (just a bunch of disks) like the physical disk drive in a laptop computer, whereas storage array is an entity that uses multiple physical disks to create many logical disks from the multiple physical disks that the array has access. Typically, storage arrays support numerous different RAID configurations. Some RAID configurations include the following: RAID, 0 striping, 1 mirroring, RAID 2 striping, RAID 5 striping+parity, RAID 6 striping+2 parity blocks. The typical storage arrays contains disk controllers to talk to the physical disk (these may be spinning or solid-state or combination), controllers to talk to the outside world (FC or NVMe as an example). A storage array is really as full system used for enabling block or file base storage access that has its own dedicated hardware that includes the disks that allow for storage of petabytes of information in a managed system. This allows for easier scaling, management, more efficient capacity allocations that a plain disk. This allows the admin to allocate the amount of space that is needed for a workload. If the workload needs 20 GB (gigabytes) of space a logical disk can be allocated with 20 GB. With a plain disk if one has a 1 TB (terabyte) disk one has to allocate a 1 TB disk for the 20 GB.

People running computer systems sometimes also create zoning between a VM and storage on SANs (storage area networks) that the hosts where the VM resides and storage are connected.

Cloud orchestration engines such as OpenStack provide for zoning of a hosts FC (fiber channel) initiator ports to the target ports of a storage provider. Other currently conventional software also provides support for zoning the VFC (virtual fiber channel) initiators of a VM (virtual machine) to the target ports of a storage provider. Some currently conventional software zones all initiators to all storage provider targets, and some currently conventional software also provides a hash algorithm that allows the initiator of a VM to be zoned to a single target on the backend.

### SUMMARY

According to an aspect of the present invention, there is a method, computer program product and/or system, for use with a computer system including a plurality of host computers, with each host computer having at least one host bus adapter port, and a set of storage array(s), with each storage array having a plurality of storage array bus adapter ports, that performs the following operations (not necessarily in the following order): (i) receiving operational data including information relevant to a set of operational aspect(s) of data communications passing through the bus adapter ports during operation of the computer system; (ii) determining, by machine logic, a set of machine logic based set of mapping rule(s) for mapping the host bus adapter ports to the storage array bus adapter ports; (iii) determining a mapping based, at least in part, upon the set of mapping rule(s); and (iv) operating the computer system so that communications made through the bus adapter ports are made according to the mapping.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a table generated by the first embodiment system;

FIG. 4B is a table generated by the first embodiment system; and

FIG. 5 is a block diagram view of a second embodiment of a system according to the present invention.

### DETAILED DESCRIPTION

In some embodiments of the present invention, machine logic implemented policies are created. These policies guide the automated creation of zoning between multiple VMs (virtual machines) and storage on SANs (storage area networks). This zoning controls hardware (such as communication ports) of various host physical machines, where the VMs and SANs are hosted and connected in mutual data communication. Some embodiments pick the ports (based on policy) to be used by the VM by pruning the list of ports from the VM and likewise the pruning the storage ports (by policy) to create the zone. In some embodiments, machine logic rule based policy(ies) determines which fabrics will be used between the VM and a storage array. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

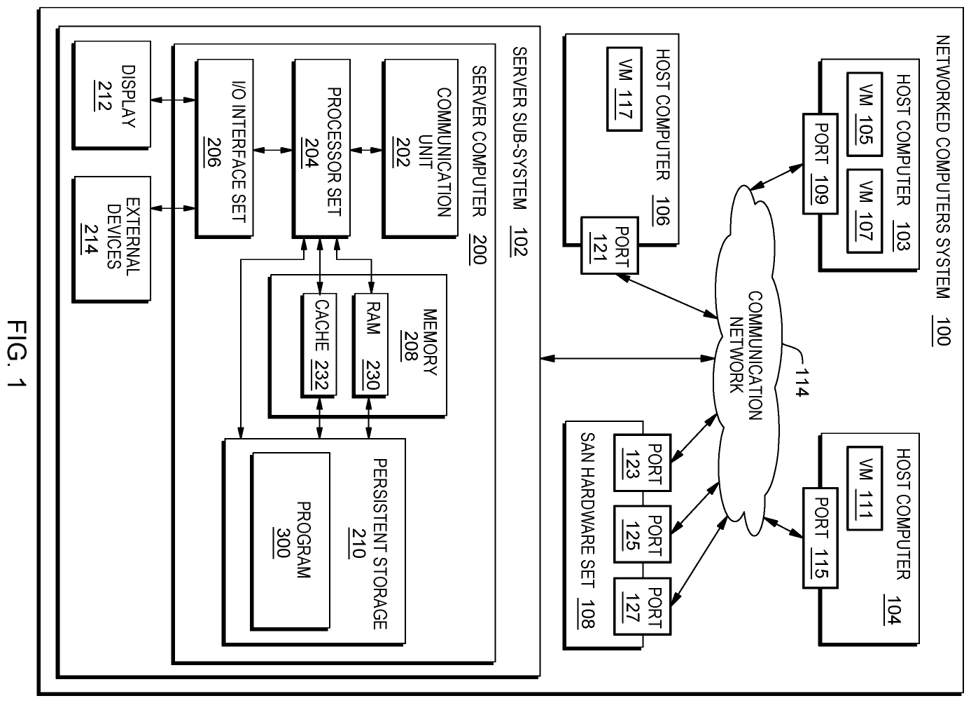

An embodiment of a possible hardware and software environment for software and/or methods according to the present invention will now be described in detail with reference to the Figures. FIG. 1 is a functional block diagram illustrating various portions of networked computers system 100, including: server subsystem 102; host subsystem 103 (including VM 105, VM107 and port 109); host subsystem 104 (including VM 111 and port 115); host computer subsystem 106 (including VM 117 and port 121); SAN hardware set 108 (including port 123 port 125 and port 127); communication network 114; server; computer 200; communication unit 202; processor set 204; input/output (I/O) interface set 206; memory device 208; persistent storage device 210; display device 212; external device set 214; random access memory (RAM) devices 230; cache memory device 232; and program 300.

Subsystem 102 is, in many respects, representative of the various computer subsystem(s) in the present invention. Accordingly, several portions of subsystem 102 will now be discussed in the following paragraphs.

Subsystem 102 may be a laptop computer, tablet computer, netbook computer, personal computer (PC), a desktop computer, a personal digital assistant (PDA), a smart phone, or any programmable electronic device capable of communicating with the client subsystems via network 114. Program 300 is a collection of machine readable instructions and/or data that is used to create, manage and control certain software functions that will be discussed in detail, below, in the Example Embodiment sub-section of this Detailed Description section.

Subsystem 102 is capable of communicating with other computer subsystems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

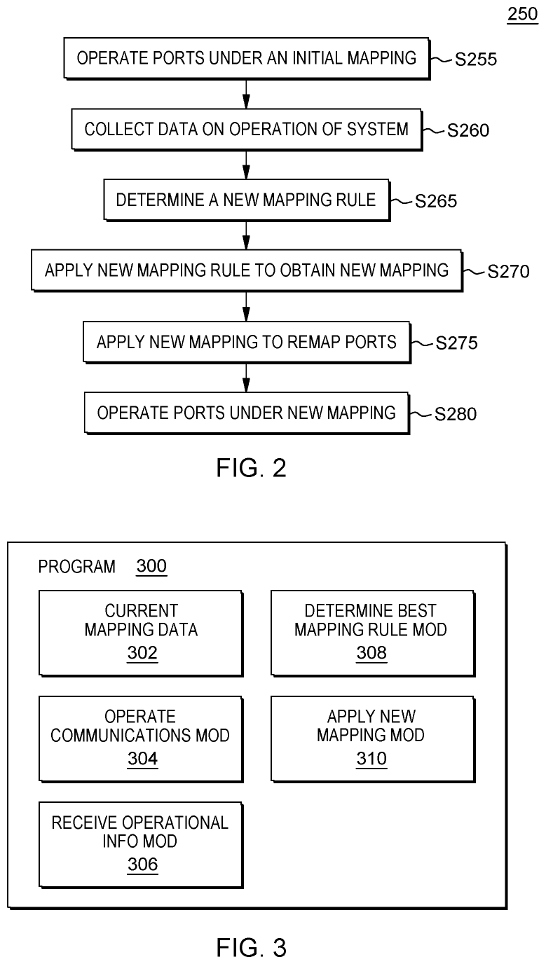

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

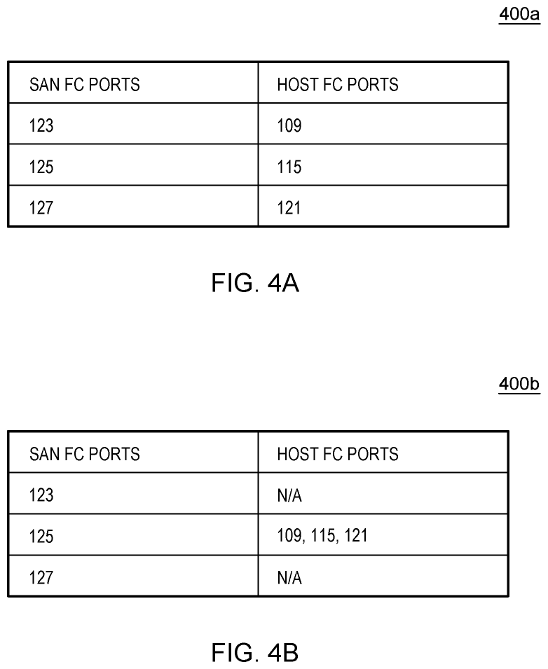

Processing begins at operation S255, where operate communications module (“mod”) 304 controls selection of fiber channel communications ports for communications between: (i) SAN hardware set 108; and (ii) host computer subsystems 103, 104, 106 (collectively including VMs 105, 107, 111, 117). This control of selection of fiber channel communications ports is performed according to information in current mapping data 302, which is shown as mapping table 400a in FIG. 4A. According to this table: (i) if VM 105 or VM 107 hosted on host computer subsystem 103 is to communicate over a fiber channel with the SAN hardware set, then this communication will take place through port 109 on the host computer side and port 123 on the SAN hardware set side: (ii) if VM 111 hosted on host computer subsystem 104 is to communicate over a fiber channel with the SAN hardware set, then this communication will take place through port 115 on the host computer side and port 125 on the SAN hardware set side: and (iii) if VM 117 hosted on host computer subsystem 106 is to communicate over a fiber channel with the SAN hardware set, then this communication will take place through port 121 on the host computer side and port 127 on the SAN hardware set side. In this example each host computer subsystem has only a single fiber channel port in order to set up a conceptually simpler example for the reader. Alternatively, each host computer could have multiple fiber channel ports.

In this example, the ports are fiber channel ports. Alternatively, any type of host bus adapter port (now known or to be developed in the future) could be used.

Processing proceeds to operation S260, where receive operational information mod 306 collects data on operation of the fiber channel communications of networked computers system 100 (see FIG. 1). In this example, fiber channel ports 123, 125 and 127 operate most efficiently when they are communicating data between 40% and 75% of the time. However, in this example, each VM 105, 107, 111, 117 only occupies its assigned SAN side port 123, 125, 127 about 10% of the time, meaning that: (i) port 123 is occupied about 20% of the time by VMs 105 and 107; (ii) port 125 is occupied about 10% of the time by VM 111; and (iv) port 127 is occupied about 10% of the time by VM 117. This, in turn, means that none of the three SAN side ports is operating efficiently.

Processing proceeds to operation S265, where determine best mapping rule mod 308 determines a new mapping rule for mapping physical host side fiber channel ports to SAN side fiber channel ports. The new rule is that all physical host side fiber channel ports will be mapped to SAN side fiber channel port 125 until SAN fiber channel port 125 is operating at 75% of its capacity, after which time new physical host fiber channel ports will begin to be assigned to SAN side fiber channel port 123. In this example, the new rule dictates that each physical host side port is assigned to only one SAN side port. Alternatively, in some embodiments, a physical host side port may be assigned to more than one SAN side port. The new rule is based on the operational information collected at operation S260. In this example, the machine logic based mapping rule is based on operational efficiency. Alternatively, the rules generated by the software program 300 may be based, in whole or in part, on other operational aspects as may be further discussed in the next subsection of this Detailed Description section.

Processing proceeds to operation S270, where apply new mapping mod 310 applies the new mapping rule to the active fiber channel ports to determine the new mapping which is: (i) shown in mapping table 400b of FIG. 4B; and (ii) stored in current mapping data 302 of program 300. Under this new mapping, SAN side port 125 should start operating at about 40% capacity because each of its four assigned VMs is likely to occupy port 125 about 10% of the time.

Processing proceeds to operation S275 where the new mapping is applied to perform the various data communications necessary to effect remapping of the ports according to current mapping data 302.

Processing proceeds to operation S280, where operate communications mod 304 operates fiber channel communications under the new mapping. As stated above, the new mapping produced by the new mapping rule will likely lead to more efficient fiber channel communications at operation S280 and beyond as new virtual machines and/or physical host computers are added to and/or subtracted from network computers system 100. Of course, as operational data continues to be collected the mapping rule may be revised and/or augmented to optimize and/or maximize fiber channel communication performance of networked computers system 100.

### III. Further Comments and/or Embodiments

Some embodiments of the present invention recognize the following facts, potential problems and/or potential areas for improvement with respect to the current state of the art: (i) at least some conventional software is lacking is fine grained control over mapping of a host or VM to specific target ports on the storage provider; and/or (ii) what is needed is the ability to zone specific hosts or on specific VIOSs (virtual input/output systems) to use specific target fiber channel ports on a storage provider.

Some embodiments of the present invention may include one, or more, of the following features, characteristics and/or advantages: (i) creates a mapping of hosts and physical ports to target ports on each storage provider; (ii) can be automated or manual; (iii) can be implemented by policy generated globally across the entire system, globally on a storage provider or host basis, or it can be in an extra spec associated with a storage provider or host; (iv) in the compute stack or the storage stack the ports for a VM could be intercepted and the initiators pruned based on a given policy; (v) in the storage stack a request to map a volume to a host or VM would be intercepted and compared against a given policy to prune the storage providers ports based on policy based; (vi) the initiators would be pruned based on the host's WWPNs (worldwide port names) so that only the ports from the policy are used to map the volume to the host or VM when both the host and the storage provider are in the policy; (vii) then the target ports for the storage provider are pruned to match the policy for this host; (viii) automated creation of a mapping table between host ports and storage ports; (ix) manual override or creation of mapping of host ports to storage ports; and/or (x) set up zoning so that VMs using specific physical ports are zoned to specific storage array ports.

While a deployer could start with a manual list as they may have a configuration spreadsheet that they use for manual deploys, some embodiments of the present invention would provide the ability to create a global map of hosts to storage providers. The inputs would be a list of hosts and a list of storage providers based on a policy. In some embodiments, the FC ports from both the hosts and the storage providers are determined and all the possible zones are determined by querying the fabrics to determine which ports are logged in and can communicate with each other. Some embodiments take into account, based on policy, previously existing zones in the environment to create a proposed zoning policy for the orchestrator. In some embodiments, additional polices indicate: (i) how many targets each initiator would be initially assigned; (ii) if hosts must have unique targets; and (iii) whether storage should use some number of targets per initiator.

Some sample policies used in various embodiments may include one, or more, of the following policies: (i) host×2 targets per initiator; (ii) host x only uses fabrics A; (iii) host x can't use the same target ports as host y; (iv) host y 1 target per initiator; (v) host y uses all fabrics; (vi) host z 1 target per initiator; (vii) host z can't use the same target ports as host y; (viii) fabric A might have 2 targets per initiator; (ix) fabric B might have 1 target per initiator; (x) storage L might have 1 target per initiator; (xi) storage M might have 2 targets per initiator; and/or (xii) storage M hosts assigned unique ports.

Some embodiments of the present invention may include one, or more, of the following features, characteristics and/or advantages: (i) instantiating a virtual machine to run on a physical host computer, with the physical host computer including a plurality physical ports; (ii) determining a storage provider that provides storage to be used in connection with the running of the virtual machine, with the storage provider including a plurality of target ports; and/or (iii) determining a mapping between the plurality of physical ports and the plurality of target ports.

Some embodiments of the present invention may include one, or more, of the following features, characteristics and/or advantages: (i) utilization of a subset of the VM's initiator ports and the storage array's targets ports in creating a mapping; (ii) utilization of the subset of the VM's initiator ports and the storage array's target ports based on a policy decision; (iii) instantiating a virtual machine to run on a physical host computer, with the physical host computer including a plurality physical ports; (iv) determining a storage provider that provides storage to be used in connection with the running of the virtual machine, with the storage provider including a plurality of target ports; (v) determining a mapping between the plurality of physical ports and the plurality of target ports; and/or (vi) allows for the VM's initiators (might be a subset) to be mapped to specific target ports on the storage provider (again might be subset) via an orchestration engine that sees both the VM and the storage ports.

Some embodiments of the present invention may include one, or more, of the following features, characteristics and/or advantages: (i) the host is single whole hardware server and a place where a VM cat be created; (ii) “physical ports” are the physical fiber channel ports in a host (typical FC cards have 2 or 4 ports each); (iii) each physical port can be have a number of virtual ports VFCs see all NPIV (N_Port ID Virtualization); (iii) “target ports” are the FC ports on the storage array—these can be physical or virtual ports and/or (iv) “storage provider” is a storage array.

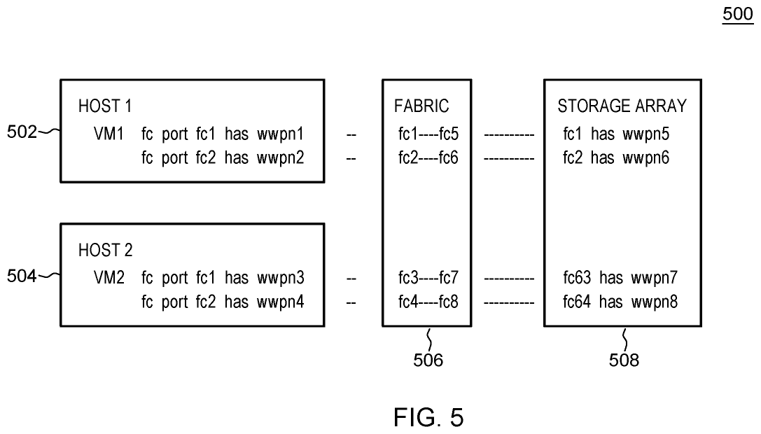

As shown in FIG. 5, system 500 includes: first host 502; second host 504; fabric 506; and storage array 508.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) for use with a computer system including a plurality of host computers, with each host computer having at least one host bus adapter port, and a set of storage arrays, with each storage array having a plurality of storage array bus adapter ports, the CIM comprising:
installing a set of virtual machines (VMs) on each host computer of the plurality of host computers;
operating the set of virtual machines installed on each host computer, with the operation including storing data by at least some VMs of the set of VMs through the host bus adapter ports of the plurality of host computers and the storage array bus adapter ports;
receiving operational data including information relevant to a set of operational aspects of data communications passing through the host bus adapter ports of the plurality of host computers during operation of the computer system;
determining, by machine logic, a set of machine logic based set of mapping rules for mapping the host bus adapter ports of the plurality of host computers to the storage array bus adapter ports;
determining a mapping based, at least in part, upon the set of mapping rules;
operating the set of virtual machines installed on each host computer, with the operation including storing data by at least some VMs of the set of VMs through the host bus adapter ports of the plurality of host computers and the storage array bus adapter ports according to the mapping;
intercepting, in a compute stack, communications made through the host bus adapter ports of the plurality of host computers;
pruning a first VM from the set of VMs based on a first policy;
intercepting, in a storage stack, a request to map a volume to the set of VMs; and
pruning at least a first storage array from the set of storage arrays based on a second policy.

2. The CIM of claim 1 wherein the bus adapter ports are fiber channel type bus adapter ports.

3. The CIM of claim 2 wherein the host bus adapter ports are located on a fiber channel card.

4. The CIM of claim 1 wherein the communications made through the bus adapter ports pass through a bus that connects the bus adapter ports.

5. The CIM of claim 1 wherein the set of storage arrays include a first storage area network type storage array.

6. The CIM of claim 1 wherein the mapping defines a fiber channel zoning so that each VM of each set of VMs using specific host bus adapter ports are zoned to specific storage array bus adapter ports.

7. A computer program product (CPP) for use with a computer system including a plurality of host computers, with each host computer having at least one host bus adapter port, and a set of storage array(s), with each storage array having a plurality of storage array bus adapter ports, the CPP comprising:
a storage device; and
computer code stored on the storage device, with the computer code including data and instructions for causing a processor(s) set to perform at least the following operations:
installing a set of virtual machines (VMs) on each host computer of the plurality of host computers,
operating the set of virtual machines installed on each host computer, with the operation including storing data by at least some VMs of the set of VMs through the host bus adapter ports of the plurality of host computers and the storage array bus adapter ports,
receiving operational data including information relevant to a set of operational aspects of data communications passing through the host bus adapter ports of the plurality of host computers during operation of the computer system,
determining, by machine logic, a set of machine logic based set of mapping rules for mapping the host bus adapter ports of the plurality of host computers to the storage array bus adapter ports,
determining a mapping based, at least in part, upon the set of mapping rules,
operating the set of virtual machines installed on each host computer, with the operation including storing data by at least some VMs of the set of VMs through the host bus adapter ports of the plurality of host computers and the storage array bus adapter ports according to the mapping,
intercepting, in a compute stack, communications made through the host bus adapter ports of the plurality of host computers,
pruning a first VM from the set of VMs based on a first policy,
intercepting, in a storage stack, a request to map a volume to the set of VMs, and
pruning at least a first storage array from the set of storage arrays based on a second policy.

8. The CPP of claim 7 wherein the bus adapter ports are fiber channel type bus adapter ports.

9. The CPP of claim 8 wherein the host bus adapter ports are located on a fiber channel card.

10. The CPP of claim 7 wherein the communications made through the bus adapter ports pass through a bus that connects the bus adapter ports.

11. The CPP of claim 7 wherein the set of storage arrays include a first storage area network type storage array.

12. The CPP of claim 7 wherein the mapping defines a fiber channel zoning so that each VM of each set of VMs using specific host bus adapter ports are zoned to specific storage array bus adapter ports.

13. A computer system (CS) comprising:
a plurality of host computers, with each host computer having at least one host bus adapter port;
a set of storage array(s), with each storage array having a plurality of storage array bus adapter ports;
a processor(s) set;
a storage device; and
computer code stored on the storage device, with the computer code including data and instructions for causing a processor(s) set to perform at least the following operations:
installing a set of virtual machines (VMs) on each host computer of the plurality of host computers,
operating the set of virtual machines installed on each host computer, with the operation including storing data by at least some VMs of the set of VMs through the host bus adapter ports of the plurality of host computers and the storage array bus adapter ports,
receiving operational data including information relevant to a set of operational aspects of data communications passing through the host bus adapter ports of the plurality of host computers during operation of the computer system,
determining, by machine logic, a set of machine logic based set of mapping rules for mapping the host bus adapter ports of the plurality of host computers to the storage array bus adapter ports,
determining a mapping based, at least in part, upon the set of mapping rules,
operating the set of virtual machines installed on each host computer, with the operation including storing data by at least some VMs of the set of VMs through the host bus adapter ports of the plurality of host computers and the storage array bus adapter ports according to the mapping,
intercepting, in a compute stack, communications made through the host bus adapter ports of the plurality of host computers,
pruning a first VM from the set of VMs based on a first policy,
intercepting, in a storage stack, a request to map a volume to the set of VMs, and
pruning at least a first storage array from the set of storage arrays based on a second policy.

14. The CS of claim 13 wherein the bus adapter ports are fiber channel type bus adapter ports.

15. The CS of claim 14 wherein the host bus adapter ports are located on a fiber channel card.

16. The CS of claim 13 wherein the communications made through the bus adapter ports pass through a bus that connects the bus adapter ports.

17. The CS of claim 13 wherein the set of storage arrays include a first storage area network type storage array.

18. The CS of claim 13 wherein the mapping defines a fiber channel zoning so that each VM of each set of VMs using specific host bus adapter ports are zoned to specific storage array bus adapter ports.
